(19) United States
(12) Patent Application Publication
(10) Pub. No.: US 2011/0135135 A1
(43) Pub. Date: Jun. 9, 2011

(54) Wireless Headsets Having an Intuitive Man Machine Interface and Related Systems and Methods

(76) Inventors: Jan Hofman, Dwingeloo (NL); Richard Ten Hoor, Smilde (NL)

(21) Appl. No.: 12/630,096

(22) Filed: Dec. 3, 2009

(51) Int. Cl. H04R 25/02; H04B 7/00; G06F 3/033

(52) U.S. Cl. 381/375; 455/41.3; 345/157; 381/375

(57) ABSTRACT

Wireless devices are provided that are configured to communicate with portable electronic devices. The wireless devices include a housing and a speaker attached to the housing. The wireless device is configured to be received by an ear of a user of the wireless device. Movement of the housing and/or speaker of the wireless device causes a change in functionality of the wireless device and/or the portable electronic device. Related systems and methods are also provided herein.

### FIELD

The present invention relates to portable electronic devices, and, more particularly, to wireless devices used for hands free operation of portable electronic devices and associated systems and methods.

### BACKGROUND

Portable electronic devices, such as mobile terminals, are commonplace in today's society. People use portable devices everywhere, such as their homes, offices, cars and the like. Many users use the portable electronic device in combination with a wireless headset, which allows the user to talk hands free. This may desirable, for example, when the device is being used in a vehicle so that both hands can remain on the steering wheel. One wireless headset is a Bluetooth headset. Bluetooth technology was designed originally for a much wider application, it has today become largely for voice transmission. Conventional portable electronic devices typically include a Bluetooth transmitter, therefore, the portable electronic device can communicate with a Bluetooth headset.

Bluetooth headsets come in many different styles. For example, standard Bluetooth headsets, such as the headsets 100 and 100′ illustrated in FIGS. 1A and 1B, are often a single-side monaural earpiece, which can access the Headset/handsfree profile of Bluetooth. Depending on the operating system of the portable electronic device this type of headset will either play music at a very low quality because the portable electronic device is converting it into a voice signal or will be unable to play music at all because the portable electronic device cannot perform such a conversion. Users who would like a stereo-music playing Bluetooth headset, such as the headset 200 illustrated in FIG. 2, should look for a headset with the A2DP profile. Users should note that some A2DP-equipped headsets will automatically de-activate the microphone function during music-listening, so if these headsets are paired to a computer via a Bluetooth connection, the headset may either disable the stereo function or the microphone function.

### SUMMARY OF THE INVENTION

Some embodiments of the present invention provide wireless devices configured to communicate with portable electronic devices. The wireless devices include a housing and a speaker attached to the housing. The wireless device is configured to be received by an ear of a user of the wireless device. Movement of the housing and/or speaker of the wireless device causes a change in functionality of the wireless device and/or the portable electronic device.

In further embodiments of the present invention, the speaker attached to the housing may be received by the ear of the user such that the speaker of the wireless device is fixed in the ear of the user. The housing may be configured to be moved by the user to cause the change in functionality of the wireless device and/or portable electronic device.

In still further embodiments of the present invention, the wireless device may include a joystick switch in the housing connected to the speaker.

In some embodiments of the present invention, the movement of the housing and/or speaker may cause the joystick switch to move up, down, left, right or in.

In further embodiments of the present invention, the change in functionality of the wireless device and/or portable electronic device may include a change in volume to the speaker, initiation of a call received by the portable electronic device, termination of a call received by the portable electronic device and/or muting the speaker of the wireless device.

In still further embodiments of the present invention, the housing of the wireless device may be fixed in a hand of the user and the speaker of the wireless device may be moved by the user to cause the change in functionality of the wireless device and/or portable electronic device. The wireless device may be configured to be used as a gaming controller for playing games on the portable electronic device and/or a game console or as a pointing device for browsing menus on the portable electronic device.

In some embodiments of the present invention, the wireless device may be a Bluetooth headset.

Further embodiments of the present invention provide a system for hands free operation of a portable electronic device, the system including a portable electronic device and a wireless device. The portable electronic device includes a wireless transceiver and the wireless device is configured to wirelessly communicate with the wireless transceiver of the portable electronic device. The wireless device includes a housing and a speaker attached to the housing. The wireless device is configured to be received by an ear of a user of the wireless device. Movement of the housing and/or speaker of the wireless device causes a change in functionality of the wireless device and/or the portable electronic device.

In still further embodiments of the present invention, the speaker attached to the housing may be received by the ear of the user such that the speaker of the wireless device is fixed in the ear of the user. The housing may be configured to be moved by the user to cause the change in functionality of the wireless device and/or portable electronic device.

In some embodiments of the present invention, the wireless device may include a joystick switch in the housing connected to the speaker. The movement of the housing and/or speaker may cause the joystick switch to move up, down, left, right or in.

In further embodiments of the present invention, the housing of the wireless device may be fixed in a hand of the user and the speaker of the wireless device may be configured to be moved by the user to cause the change in functionality of the wireless device and/or portable electronic device.

In still further embodiments of the present invention, the wireless device may be configured to be used as a gaming controller for playing games on the portable electronic device and/or a game console or as a pointing device for browsing menus on the portable electronic device.

Some embodiments of the present invention provide methods for operating a wireless device configured to communicate with a portable electronic device. The wireless device includes a housing and a speaker attached to the housing. The wireless device is configured to be received by an ear of a user of the wireless device. The method includes moving the housing and/or speaker of the wireless device to change functionality of the wireless device and/or the portable electronic device.

In further embodiments of the present invention, the method may further include positioning the speaker attached to the housing in the ear of the user such that the speaker of the wireless device is fixed in the ear of the user and moving the housing to cause the change in functionality of the wireless device and/or portable electronic device.

In still further embodiments of the present invention, the method may further include moving the housing and/or speaker comprises moving the housing and/or speaker to cause a joystick switch in the housing to move up, down, left, right or in.

In some embodiments of the present invention, the method may further include positioning the housing of the wireless device in a hand of the user such that the housing is fixed in the hand of the user and moving the speaker of the wireless device causing the change in functionality of the wireless device and/or portable electronic device.

In further embodiments of the present invention, the wireless device may be used as a gaming controller for playing games on the portable electronic device and/or a game console or as a pointing device for browsing menus on the portable electronic device.

In still further embodiments of the present invention, the wireless device may be a Bluetooth headset.

### BRIEF DESCRIPTION OF THE DRAWINGS

FIG. 1A is a diagram illustrating a standard Bluetooth headset.

FIG. 1B is a diagram illustrating a SonyEricsson Bluetooth headset.

FIG. 2 is a diagram illustrating a conventional Stereo Bluetooth headset.

FIG. 3 is a schematic block diagram illustrating a system including a portable electronic device, wireless headset and cellular communication system in accordance with some embodiments of the present invention.

FIG. 4 through 8D are diagrams illustrating wireless devices according to some embodiments of the present invention.

FIGS. 9 through 11 are flowcharts illustrating operations of wireless devices according to various embodiments of the present invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

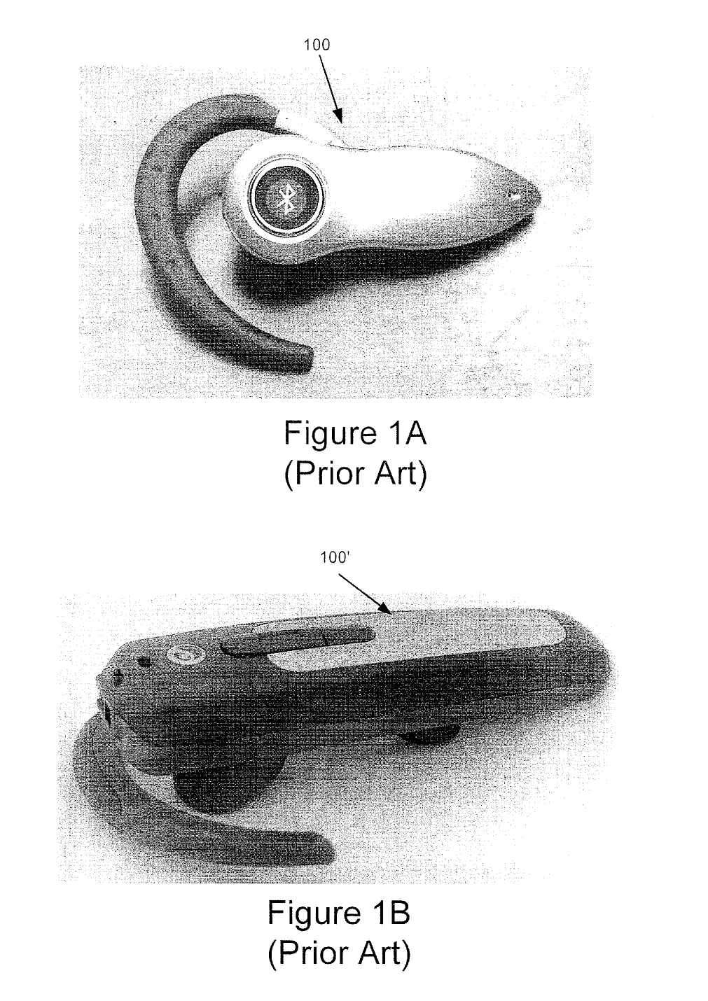

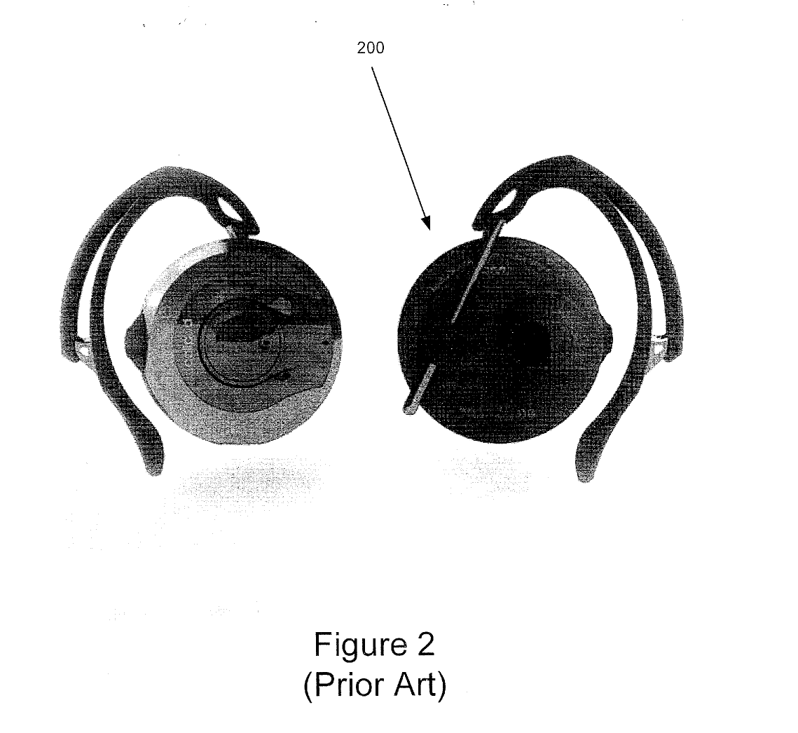

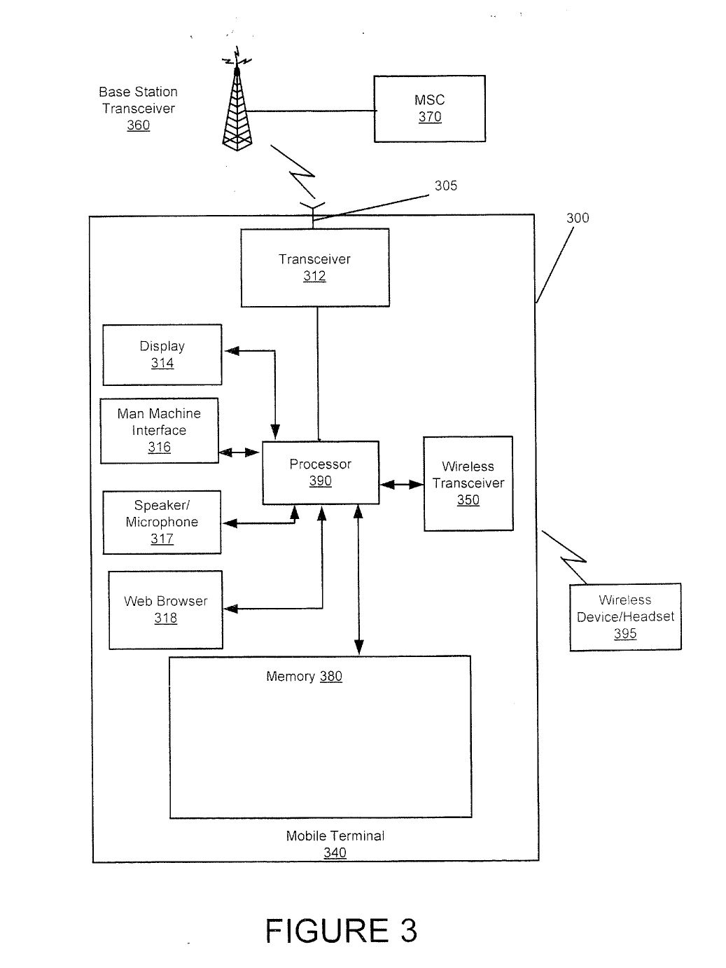

As illustrated by the conventional headsets in FIGS. 1A through 2, conventional Bluetooth headsets typically have one or more buttons on the headset itself, which allow the user to operate the functions of the portable electronic device through the headset. Due to the small size of these buttons, it may be difficult for a user who may be, for example, operating a vehicle, to find these buttons when the headset is affixed to the user's ear. Accordingly, some embodiments of the present invention provide a wireless headset including an intuitive man machine interface (MMI) that may be easier to operate when the headset is affixed to the user's ear as will be discussed in detail with respect to FIGS. 3 through 11D.

Referring first to FIG. 3, a schematic block diagram illustrating a system including a portable electronic device 340 communicating with a wireless headset 395 according to some embodiments of the present invention will be discussed. As used herein, the term “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver. Any portable electronic device capable of operating in accordance with some embodiments of the present invention may be used without departing from the scope of the present invention.

As illustrated in FIG. 3, the portable electronic device 340 includes a portable housing 300 and may include a display 314, a man machine interface (MMI) 316, a speaker/microphone 317, a web browser 318, a transceiver 312, a memory 380 and a wireless transceiver 350, any of which may communicate with a processor 390. The wireless transceiver 350 may support short range wireless communication such as Bluetooth, WLAN and Wi-Fi without departing from the scope of the present invention. It will be understood that the wireless transceiver 350 and the transceiver 312 may be combined without departing from the scope of the present invention. The processor 390 can be any commercially available or custom microprocessor.

As illustrated in FIG. 3, the portable electronic device communicates with a base station transceiver 360 connected to a mobile switching center (“MSC”) 370 in accordance with some embodiments of the present invention. The transceiver 312 typically includes a transmitter circuit and a receiver circuit, which respectively transmit outgoing radio frequency signals to the base station transceiver 360 and receive incoming radio frequency signals, such as voice and data signals, from the base station transceiver 260 via an antenna 205. The antenna 305 may be an embedded antenna, a retractable antenna or any antenna known to those having skill in the art without departing from the scope of the present invention. The radio frequency signals transmitted between the portable electronic device 340 and the base station transceiver 360 may include both traffic and control signals (e.g., paging signals/messages for incoming calls), which are used to establish and maintain communication with another party or destination. The processor 390 may support various functions of the portable electronic device, including a wireless transceiver configured to communicate with the wireless device/headset 395 according to some embodiments of the present invention as will be discussed further herein.

It will be understood that in some embodiments of the present invention, the transceiver 312 may be a short range transceiver. The short range transceiver may be, for example, a Bluetooth transceiver, which may allow for high transfer rates of data over relatively short distances. It will be further understood that portable electronic devices 340 according to some embodiments of the present invention may include a wireless transceiver and a short range transceiver/transmitter as discussed above.

In some embodiments of the present invention, the base station transceiver 360 comprises the radio transceiver(s) that defines an individual cell in a cellular network and communicates with the portable electronic device 340 and other portable electronic devices in the cell using a radio-link protocol. Although only a single base station transceiver 360 is shown, it will be understood that many base station transceivers may be connected through, for example, a mobile switching center 370 and other devices to define a wireless communications network.

Although the present invention may be embodied in communication devices or systems, such as the portable electronic device 340, the present invention is not limited to such devices and/or systems. Instead, the present invention may be embodied in any apparatus that may be configured to download, install, execute and/or uninstall applications from a server in accordance with embodiments of the present invention.

Wireless devices 395 in accordance with embodiments of the present invention are configured to communicate with a portable electronic device, for example, portable electronic device 340. In some embodiments of the present invention, the wireless device 395 is a wireless headset, for example, a Bluetooth headset, that allows hands free operation of the portable electronic device 340.

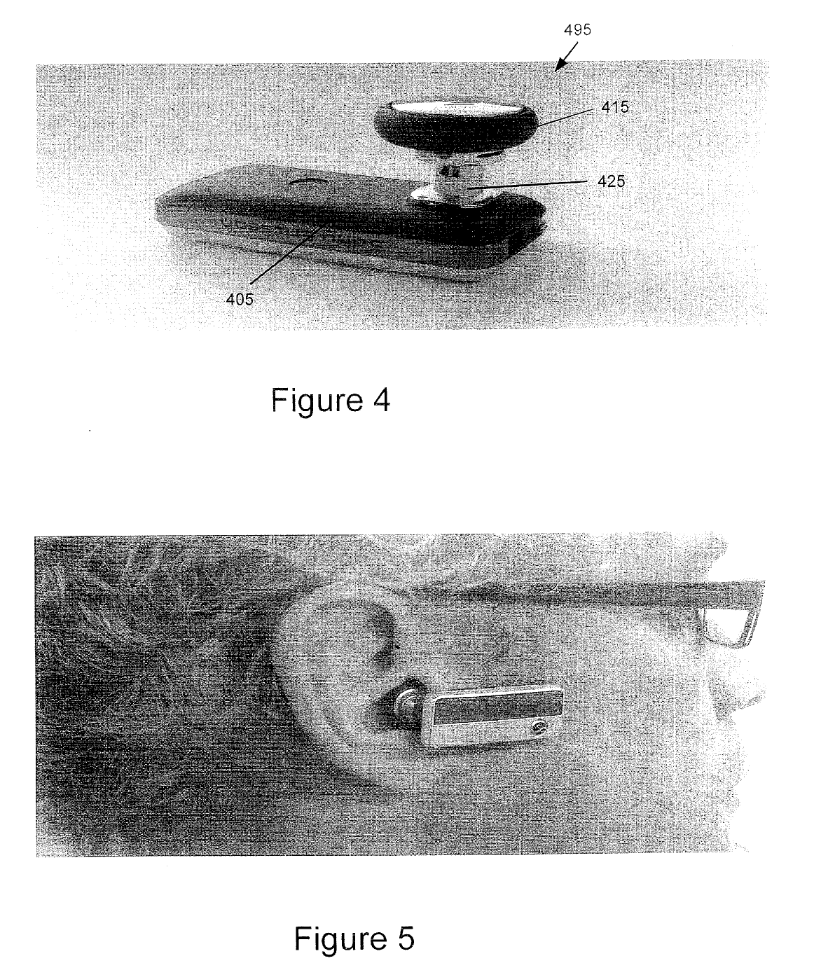

As illustrated in FIG. 3, a system for hands free operation of a portable electronic device in accordance with some embodiments of the present invention may include a portable electronic device 340 including a wireless transceiver 312/350 and a wireless device 395 configured to wirelessly communicate with the wireless transceiver 312/350 of the portable electronic device 340. As will be discussed below with respect to FIGS. 4 through 8D, wireless devices in accordance with some embodiments of the present invention include a housing and a speaker attached to the housing. The speaker is configured to be received by an ear of a user of the wireless device. Movement of the housing and/or speaker of the wireless device causes a change in functionality of the wireless device and/or the portable electronic device.

Various aspects of the wireless device/headset 395 in accordance with some embodiments of the present invention will now be discussed with respect to FIGS. 4 through 8D. As discussed above, conventional wireless headsets typically have very small buttons that may be hard to use. Accordingly, some embodiments of the present invention provide a wireless device/headset 395 that provides and intuitive man machine interface that may be easier to use while, for example, driving a vehicle.

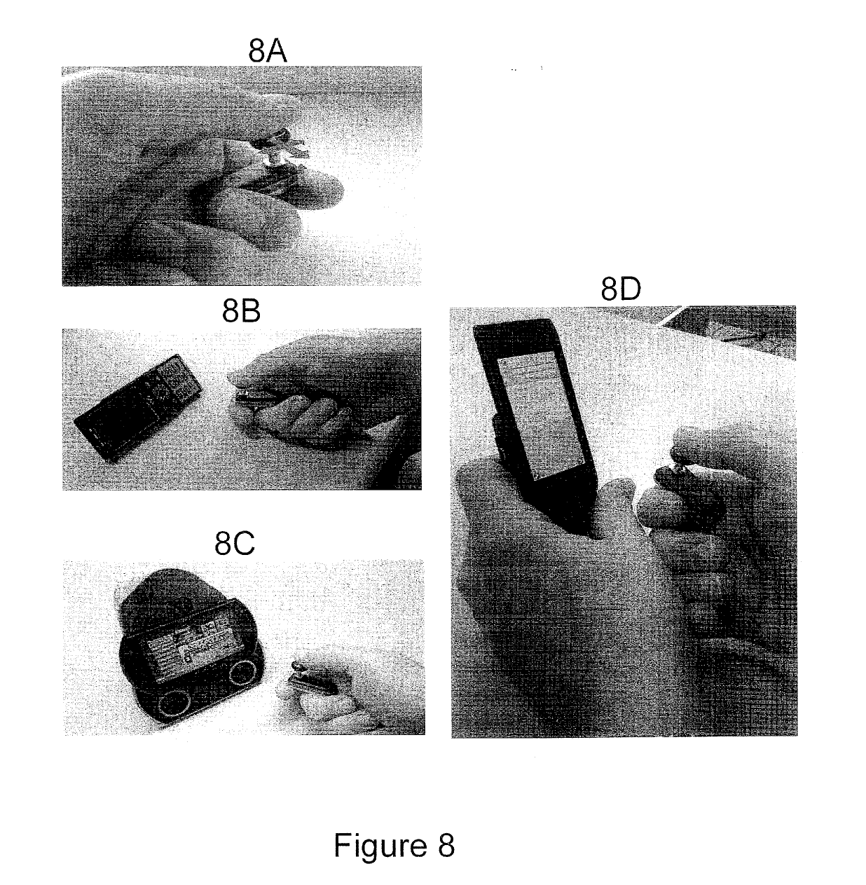

Referring first to FIG. 4, a wireless device/headset 495 in accordance with some embodiments of the present invention will be discussed. As illustrated in FIG. 4, the wireless device 495 includes a housing 405 that houses all of the electronics of the wireless headset 495 known to those of skill in the art and a speaker portion 415. The speaker portion 415 is attached to the housing 405. The wireless device 495 is configured to be received by an ear of a user of the wireless device 495 as illustrated in FIG. 5. However, it will be understood that although the wireless device 495 is configured to be received by an ear of the user, the wireless device 495 does not have to be used in the ear of the user as will be discussed further below with respect to FIGS. 8A through 8D.

Referring again to FIG. 4, movement of the housing 415 and/or speaker 405 of the wireless device 495 causes a change in functionality of the wireless device and/or the portable electronic device. The change in functionality of the wireless device 495 and/or the portable electronic device (340, FIG. 3) may include, for example, a change in volume to the speaker, initiation of a call received by the portable electronic device, termination of a call received by the portable electronic device and/or muting the speaker of the wireless device. These functions are provided for exemplary purposes only and, therefore, embodiments of the present invention are not limited to the examples.

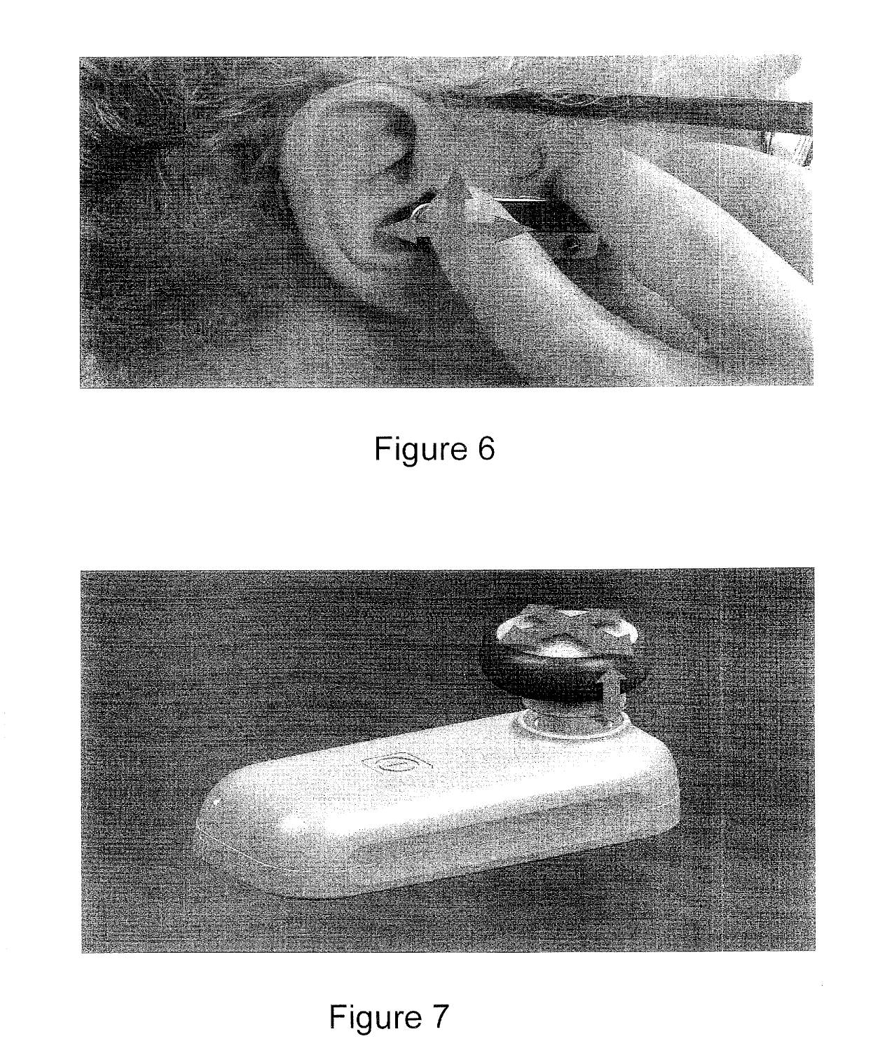

In some embodiments of the present invention, the housing 405 is connected to the speaker portion 415 via a joystick switch 425, for example, a 5-axis joystick switch. As illustrated in FIGS. 6 and 7, the joystick switch 425 allows the user to move the wireless device up, down, left or right and to push the speaker part 415 in like a button (FIG. 7). Each of these movements causes a change in functionality of the wireless device 495 or the portable electronic device 340 (FIG. 3) as discussed above.

As illustrated in FIG. 6, in some embodiments of the present invention, the speaker 415 is positioned in the users ear such that the speaker 415 of the wireless device 495 is fixed in the ear of the user. The user may then move the housing 405 of the wireless device 495 left, right, up and down as illustrated in FIG. 6 or push the housing 405 in like a button as illustrated in FIG. 7. This movement causes the change in functionality of the wireless device 495 and/or portable electronic device 340 (FIG. 3).

As illustrated in FIGS. 8A through 8D, in some embodiments of the present invention, the wireless device 495 may not be positioned in the ear of a user. In these embodiments, the housing 405 of the wireless device 495 may be fixed in a hand of the user as illustrated in FIG. 8A. As further illustrated in FIG. 8A, the user may then move the speaker 415 of the wireless device 495 to cause the change in functionality of the wireless device 495 and/or portable electronic device 340 (FIG. 3). In these embodiments, the wireless device 495 may be configured to be used, for example, as a gaming controller for playing games on the portable electronic device and/or a game console as illustrated in FIGS. 8B and 8C, and as a pointing device for browsing on the portable electronic device or as a pointing device for scrolling and selecting menus on the portable electronic device as illustrated in FIG. 8D.

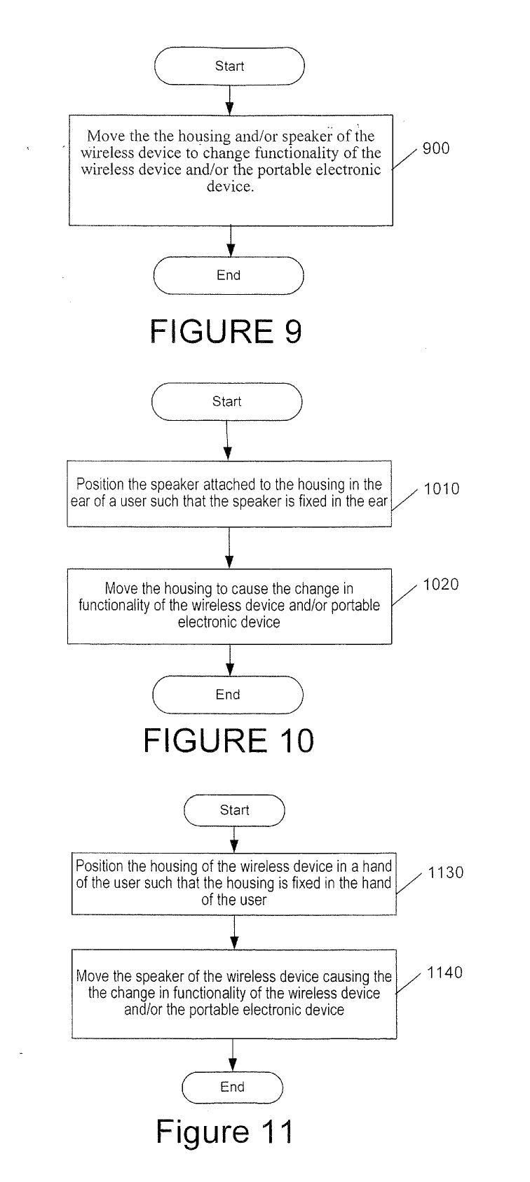

Operations of wireless devices according to various embodiments of the present invention will now be discussed with respect to the flowcharts of FIG. 9 through 11. Referring first to FIG. 9, operations for operating a wireless device configured to communicate with a portable electronic device, the wireless device including a housing and a speaker attached to the housing and configured to be received by an ear of a user of the wireless device, begin at block 900 by moving the housing and/or speaker of the wireless device to change functionality of the wireless device and/or the portable electronic device. As discussed above, the functionality of the wireless device and/or the portable electronic device may include, for example, a change in volume to the speaker, initiation of a call received by the portable electronic device, termination of a call received by the portable electronic device and/or muting the speaker of the wireless device. In some embodiments, moving the housing and/or speaker may include moving the housing and/or speaker to cause a joystick switch in the housing to move up, down, left, right or be pushed in like a button. In some embodiments of the present invention, the wireless device may be, for example, a Bluetooth headset.

Referring now to FIG. 10, operations for operating a wireless device in accordance with some embodiments of the present invention begin at block 1010 by positioning the speaker attached to the housing in the ear of the user such that the speaker of the wireless device is fixed in the ear of the user. The housing is moved to cause the change in functionality of the wireless device and/or portable electronic device (block 1020). As discussed above, although the wireless device in accordance with some embodiments of the present invention is configured to be positioned in an ear of the user, the wireless device may be use without being positioned in the ear of the user without departing from the scope of the present invention.

For example, referring to FIG. 11, operations begin at block 1130 by positioning the housing of the wireless device in a hand of the user such that the housing is fixed in the hand of the user. The speaker of the wireless device may be moved causing the change in functionality of the wireless device and/or portable electronic device (block 1140). In these embodiments, the wireless device may be used, for example, as a gaming controller for playing games on the portable electronic device and/or a game console or as a pointing device for browsing menus on the portable electronic device.

As briefly discussed above, some embodiments of the present invention provide a wireless device/headset having a unique man machine interface that is more intuitive than the small buttons on conventional devices. Accordingly, wireless devices in accordance with some embodiments of the present invention may be easier to use in, for example, a hands free situation like driving a vehicle.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A wireless device configured to communicate with a portable electronic device, the wireless device comprising:
a housing; and
a speaker attached to the housing and configured to be received by an ear of a user of the wireless device, wherein movement of the housing and/or speaker of the wireless device causes a change in functionality of the wireless device and/or the portable electronic device.

2. The wireless device of claim 1, wherein the speaker attached to the housing is received by the ear of the user such that the speaker of the wireless device is fixed in the ear of the user and wherein the housing is configured to be moved by the user to cause the change in functionality of the wireless device and/or portable electronic device.

3. The wireless device of claim 1, further comprising a joystick switch in the housing connected to the speaker.

4. The wireless device of claim 3, wherein the movement of the housing and/or speaker causes the joystick switch to move up, down, left, right or in.

5. The wireless device of claim 1, wherein the change in functionality of the wireless device and/or the portable electronic device comprises a change in volume to the speaker, initiation of a call received by the portable electronic device, termination of a call received by the portable electronic device and/or muting the speaker of the wireless device.

6. The wireless device of claim 1, wherein the housing of the wireless device is fixed in a hand of the user and wherein the speaker of the wireless device is configured to be moved by the user to cause the change in functionality of the wireless device and/or portable electronic device.

7. The wireless device of claim 6, wherein the wireless device is configured to be used as a gaming controller for playing games on the portable electronic device and/or a game console or as a pointing device for browsing menus on the portable electronic device.

8. The wireless device of claim 1, wherein the wireless device is a Bluetooth headset.

9. A system for hands free operation of a portable electronic device, the system comprising:
a portable electronic device including a wireless transceiver; and
a wireless device configured to wirelessly communicate with the wireless transceiver of the portable electronic device, the wireless device comprising:
a housing; and
a speaker attached to the housing and configured to be received by an ear of a user of the wireless device, wherein movement of the housing and/or speaker of the wireless device causes a change in functionality of the wireless device and/or the portable electronic device.

10. The system of claim 9, wherein the speaker attached to the housing is received by the ear of the user such that the speaker of the wireless device is fixed in the ear of the user and wherein the housing is configured to be moved by the user to cause the change in functionality of the wireless device and/or portable electronic device.

11. The system of claim 9, wherein the wireless device further comprises a joystick switch in the housing connected to the speaker.

12. The system of claim 11, wherein the movement of the housing and/or speaker causes the joystick switch to move up, down, left, right or in.

13. The system of claim 9, wherein the housing of the wireless device is fixed in a hand of the user and wherein the speaker of the wireless device is configured to be moved by the user to cause the change in functionality of the wireless device and/or portable electronic device.

14. The system of claim 13, wherein the wireless device is configured to be used as a gaming controller for playing games on the portable electronic device and/or a game console or as a pointing device for browsing menus on the portable electronic device.

15. A method for operating a wireless device configured to communicate with a portable electronic device, the wireless device including a housing and a speaker attached to the housing and, configured to be received by an ear of a user of the wireless device, the method comprising:
moving the housing and/or speaker of the wireless device to change functionality of the wireless device and/or the portable electronic device.

16. The method of claim 15, further comprising:
positioning the speaker attached to the housing in the ear of the user such that the speaker of the wireless device is fixed in the ear of the user; and
moving the housing to cause the change in functionality of the wireless device and/or portable electronic device.

17. The method of claim 15, further comprising moving the housing and/or speaker comprises moving the housing and/or speaker to cause a joystick switch in the housing to move up, down, left, right or in.

18. The method of claim 15, further comprising:
positioning the housing of the wireless device in a hand of the user such that the housing is fixed in the hand of the user; and
moving the speaker of the wireless device causing the change in functionality of the wireless device and/or portable electronic device.

19. The method of claim 18, further comprising using the wireless device as a gaming controller for playing games on the portable electronic device and/or a game console or as a pointing device for browsing menus on the portable electronic device.

20. The method of claim 15, wherein the wireless device is a Bluetooth headset.
